(19) United States
(12) Patent Application Publication
(10) Pub. No.: US 2026/0237726 A1
(43) Pub. Date: Aug. 13, 2026

(54) High-Entropy Oxide with Engineered Defects to Deliver Superior Ion Transport and High Capacity Under High-Rate Conditions

(71) Applicant: The Regents of The Univesity of Michigan, Ann Arbor, MI (US)

(72) Inventors: Wei Lu, Ann Arbor, MI (US); Seung Hoon Chae, Ann Arbor, MI (US)

(21) Appl. No.: 19/533,573

(22) Filed: Feb. 9, 2026

Related U.S. Application Data
(60) Provisional application No. 63/756,893, filed on Feb. 11, 2025.

(51) Int. Cl. H01M 10/0525

(52) U.S. Cl. CPC H01M 10/0525

(57) ABSTRACT

A high entropy oxide composition comprises:
(i) a first oxide having a formula (I):

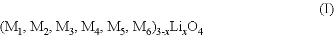

wherein x is in a range of 0 to less than 3,
wherein each of M_{1,} M_{2,} M_{3,} M₄, and M₅ comprise cations of a different transition metal, and M₆ is nothing or at least one additional cation different from M₁, M₂, M₃, M₄, and M₅,
wherein the first oxide has a first phase structure, and
(ii) a second oxide having a formula (II):

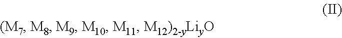

wherein y is in a range of 0 to less than 2,
wherein each of M_{7,} M_{8,} M_{9,} M₁₀, and M₁₁ comprise cations of one of the different transition metals, and M₁₂ comprises nothing or at least one additional cation different from M₇, M₈, M₉, M₁₀, and M₁₁,
wherein the second oxide has a second phase structure.

### CROSS-REFERENCES TO RELATED APPLICATIONS

This application is based on, claims benefit of, and claims priority to U.S. Application No. 63/756,893, filed on Feb. 11, 2025, which is hereby incorporated by reference herein in its entirety for all purposes.

### STATEMENT REGARDING FEDERALLY SPONSORED RESEARCH

This invention was made with government support under grant DE-AR0001553 awarded by the Department of Energy. The government has certain rights in the invention.

### BACKGROUND OF THE INVENTION

### 1. Field of the Invention

This invention relates to improved high-entropy oxides, and improved methods for synthesizing high-entropy oxides.

### 2. Description of the Related Art

Increasing energy demands these days require the development of lithium-ion batteries (LIBs) toward higher energy density. Graphite, the currently commercialized anode material for lithium-ion batteries, has a limited theoretical specific capacity (372 mAh g⁻¹). To meet the growing demands, transition metal oxides (TMOs) have been developed as next-generation LIBs anode materials due to their high theoretical capacity ranging from 600 to 1100 mAh g⁻¹. However, TMOs still face challenges such as structural degradation on continuous discharge-charge cycles, including irreversible phase change and volumetric expansion, which lead to rapid capacity fading and poor reversibility.

Recently, high-entropy oxides (HEOs) have emerged as a potential candidate for advanced LIB anodes. Its entropy stabilization effect to improve the structural stability can be derived by increasing the configurational entropy (S_{config}) of the system. Five or more cations in equimolar or near-equimolar ratios are randomly distributed on the lattice sites. It is reported that the lattice in HEOs can be preserved, serving as a host matrix during the conversion reaction, and therefore ions can diffuse back into the crystal structure after being trapped in the matrix. Subsequently, its parent structure can be readily recovered. Compared to conventional TMOs, HEOs demonstrate higher structural stability leading to excellent capacity retention and cyclic performance. Nevertheless, most of the synthesis methods of HEOs take long times (more than 10 hours) and require multi-step, which is tedious and energy-consuming thereby hindering practical fabrication and widespread use of HEO materials. Furthermore, it is still highly necessary to enhance intrinsic conductivity of HEOs.

What is needed therefore are improved high-entropy oxides, and improved methods for synthesizing high-entropy oxides.

### SUMMARY OF THE INVENTION

The present disclosure meets the foregoing needs by providing improved high-entropy oxides, and improved methods for synthesizing high-entropy oxides.

In one aspect, the present disclosure provides a composition comprising:
(a) a ceramic material including:
   (i) a first oxide having a formula (I):

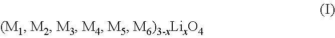

wherein x is in a range of 0 to less than 3,
wherein M₁ comprises cations of a first transition metal,
wherein M₂ comprises cations of a second transition metal,
wherein M₃ comprises cations of a third transition metal,
wherein M₄ comprises cations of a fourth transition metal,
wherein M₅ comprises cations of a fifth transition metal,
wherein M₆ comprises nothing or at least one additional cation different from M₁, M₂, M₃, M₄, and M₅,
wherein the first oxide has a first phase structure, and
(ii) a second oxide having a formula (II):

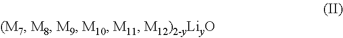

wherein y is in a range of 0 to less than 2,
wherein M₇ comprises cations of the first transition metal,
wherein M₈ comprises cations of the second transition metal,
wherein M₉ comprises cations of the third transition metal,
wherein M₁₀ comprises cations of the fourth transition metal,
wherein M₁₁ comprises cations of the fifth transition metal,
wherein M₁₂ comprises nothing or at least one additional cation different from M₇, M₈, M₉, M₁₀, and M₁₁,
wherein the second oxide has a second phase structure, and
wherein each of the first transition metal, the second transition metal, the third transition metal, the fourth transition metal, and the fifth transition metal are different transition metals.

In yet another aspect, the present disclosure provides an electrochemical cell including an anode comprising a composition of the present disclosure; a cathode comprising a lithium host material; and an electrolyte configured to facilitate the transfer of ions between the anode and the cathode.

In still another aspect, the present disclosure provides an electrochemical cell including an anode; a cathode comprising a composition of the present disclosure; and an electrolyte configured to facilitate the transfer of ions between the anode and the cathode.

In yet another aspect, the present disclosure provides a method for synthesizing a high entropy oxide composition. The method comprises: (a) providing a solution of a fuel and an oxidant, wherein the fuel comprises glycine, urea, citric acid, or a mixture thereof, and wherein the oxidant comprises: a first oxidant including a first metal nitrate and/or a first metal nitrate hydrate, a second oxidant including a second metal nitrate and/or a second metal nitrate hydrate, a third oxidant including a third metal nitrate and/or a third metal nitrate hydrate, a fourth oxidant including a fourth metal nitrate and/or a fourth metal nitrate hydrate, a fifth oxidant including a fifth metal nitrate and/or a fifth nitrate metal hydrate, and a sixth oxidant including lithium nitrate and/or a lithium nitrate hydrate; and (b) increasing a temperature of the solution of the oxidant and the fuel such that the first oxidant, the second oxidant, the third oxidant, the fourth oxidant, the fifth oxidant, and the sixth oxidant thermally decompose, yielding nanoparticles of a high entropy oxide composition.

The present disclosure unveils an innovative high-entropy oxide (HEO) electrode material featuring controlled defects that enable superior ion transport, along with a detailed synthesis route for its fabrication. HEOs are an emerging new class of materials that serve as advanced anode materials or advanced cathode materials for lithium-ion batteries (LIBs), offering structural stability during electrochemical reactions. However, current HEOs suffer from low intrinsic conductivity and restricted kinetics of diffusion-driven electrochemical processes, which hinders their high-performance potential at high current rates. This disclosure demonstrates an innovative approach that combines defect engineering and phase structure design through a one-step combustion synthesis route to dramatically enhance redox kinetics. This disclosure introduces abundant oxygen vacancies and phase boundaries into HEOs by incorporating a secondary phase.

High Entropy Oxides of the present disclosure can serve as anodes or cathodes for lithium-ion batteries, have applications in thermal barrier coatings, and can be used for 3D printing and additive manufacturing materials.

These and other features, aspects, and advantages of the present invention will become better understood upon consideration of the following detailed description, drawings, and appended claims.

### BRIEF DESCRIPTION OF THE DRAWINGS

FIG. 1 is a schematic of a non-limiting example embodiment of an electrochemical cell of the present disclosure.

FIG. 1A shows an SEM image of HEO-D_{R}FL panel (a), HEO-D_{R} panel (b), and HEO-NP panel (c). The morphology of all samples reveals nanoparticle structures on the porous backbone.

FIG. 2 shows XRD characterization of HEO-D_{R}FL, HEO-D_{R} and HEO-NP. Panel (a): All samples obtained from combustion synthesis have a spinel phase as a major phase, and rock-salt phase as a secondary phase. Panel (b): Peak shift shows the d spacing of lithium-doped samples is lower than HEO-NP, demonstrating higher concentration of oxygen vacancies. Panel (c): Rietveld refinement results show that the lattice parameters of the rock-salt phase in lithium-doped samples and the spinel phase in HEO-D_{R} are lower than those in HEO-NP, attributed to oxygen vacancies.

FIG. 3 shows XPS characterization of HEO-D_{R}FL, HEO-D_{R}, HEO-NP. Panel (a): Oxygen peak confirms HEO-D_{R}FL has the highest concentration of oxygen vacancies. HEO-D_{R} has a higher concentration of oxygen vacancies than HEO-NP. Panels (b, c, d, e, f): XPS peaks of Mn, Fe, Co, Cu and Ni element of HEO-D_{R}FL, HEO-D_{R}, HEO-NP reveal the valence state of each element.

FIG. 4 shows a TEM image of HEO-D_{R}FL panel (a), and selected area electron diffraction (SAED) patterns of HEO-D_{R}FL panel (b), HEO-D_{R} panel (c), HEO-NP panel (d), confirming the coexistence of spinel and rock-salt phase.

FIG. 5 shows high resolution TEM (HRTEM) images of HEO-D_{R}FL panel (a), HEO-D_{R} panel (b) and HEO-NP panel (c), demonstrating the coexistence of spinel and rock-salt phase, and phase boundaries.

FIG. 6 shows an EDS mapping of HEO-D_{R}FL panel (a), HEO-D_{R} panel (b), and HEO-NP panel (c), demonstrating homogeneous distribution of all elements in HEO-D_{R}FL, while little segregation of copper element in HEO-D_{R} and HEO-NP, which are fabricated in stoichiometric condition. In HEO-D_{R}FL panel (a), the left to right sub-panels are: high-angle annular dark field (HAADF), iron, cobalt, oxygen, nickel, manganese, and copper. In HEO-D_{R} panel (b), the left to right sub-panels are: high-angle annular dark field (HAADF), oxygen, iron, cobalt, nickel, manganese, and copper. In HEO-NP panel (c), the left to right sub-panels are: high-angle annular dark field (HAADF), oxygen, iron, cobalt, nickel, manganese, and copper.

FIG. 7 shows electrochemical behaviors of HEO-D_{R}FL, HEO-D_{R} and HEO-NP anodes in half-cell configuration where lithium metal was used as counter and reference electrodes. Panel (a): Voltage curve of the three samples in initial cycle of rate capability test. Panel (b): Rate capability of the three composites show that HEO-D_{R}FL has superior performance compared to the other two controls. Panel (c): Long cyclic stability test of the three samples at a rate of 2000 mA/g.

FIG. 8 panel (a) shows electrochemical impedance spectroscopy (EIS) results of HEO-D_{R}FL, HEO-D_{R} and HEO-NP after CV cycles. Panel (b) shows the relationship between Z′ and w^{-1/2} in the low frequency region from the EIS result, where the slopes of the fitting curve are inversely proportional to Li⁺ diffusion rate. It reveals that HEO-D_{R}FL shows superior lithium diffusivity compared to two other control samples.

FIG. 9 panel (a) shows galvanostatic intermittent titration technique (GITT) curve, and panel (b) shows the estimated Li⁺ diffusion coefficient at different states of charge of HEO-D_{R}FL, HEO-D_{R} and HEO-NP, demonstrating higher diffusivity of lithium doped samples (HEO-D_{R}FL, HEO-D_{R}) than HEO-NP.

FIG. 10 shows density functional theory (DFT) calculation results. Panels (a, b) show calculated band structures of high entropy oxide spinel phase with oxygen vacancies. Panels (c, d) show calculated band structures of high entropy oxide spinel phase without oxygen vacancies. Panels (e, f) show calculated band structures of high entropy oxide rock-salt phase with oxygen vacancies. Panels (g, h) show calculated band structures of high entropy oxide rock-salt phase without oxygen vacancies. The narrower band gaps of oxygen-vacancy-rich structures demonstrate that introduction of oxygen vacancies can improve the electronic conductivity of high entropy oxides.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

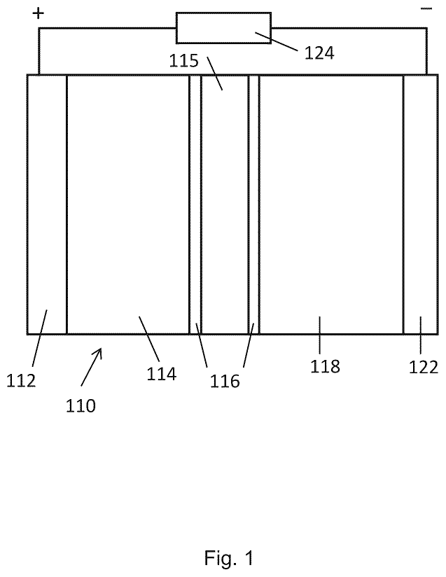

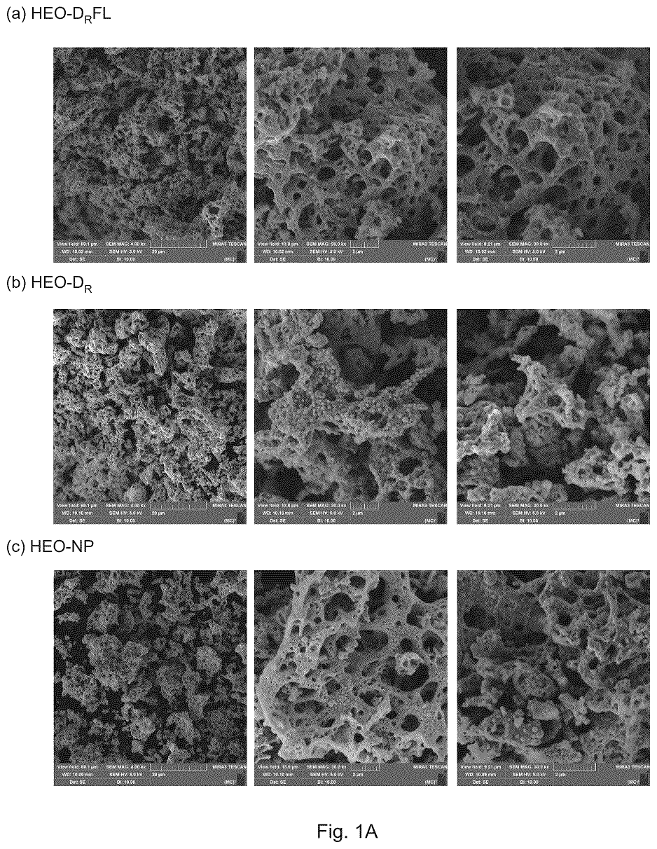

A non-limiting example embodiment of an electrochemical cell of the present invention is depicted in FIG. 1. The electrochemical cell 110 of FIG. 1 includes a current collector 112 in contact with a cathode 114. At least a portion of an amount of a liquid electrolyte 116 is arranged between the cathode 114 and an anode 118, which is in contact with a current collector 122. A separator 115 keeps the cathode 114 and the anode 118 from touching but allows metal ions through. The current collectors 112 and 122 of the electrochemical cell 110 may be in electrical communication with an electrical component 124. The electrical component 124 could place the electrochemical cell 110 in electrical communication with an electrical load that discharges the battery or a charger that charges the battery.

In one embodiment of the electrochemical cell 110, a suitable active material for the anode 118 of the electrochemical cell 110 is a composition comprising:
(a) a ceramic material including:
   (i) a first oxide having a formula (I):

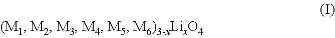

wherein x is in a range of 0 to less than 3,
wherein M₁ comprises cations of a first transition metal,
wherein M₂ comprises cations of a second transition metal,
wherein M₃ comprises cations of a third transition metal,
wherein M₄ comprises cations of a fourth transition metal,
wherein M₅ comprises cations of a fifth transition metal,
wherein M₆ comprises nothing or at least one additional cation different from M₁, M₂, M₃, M₄, and M₅,
wherein the first oxide has a first phase structure, and
(ii) a second oxide having a formula (II):

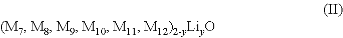

wherein y is in a range of 0 to less than 2,
wherein M₇ comprises cations of the first transition metal,
wherein M₈ comprises cations of the second transition metal,
wherein M₉ comprises cations of the third transition metal,
wherein M₁₀ comprises cations of the fourth transition metal,
wherein M₁₁ comprises cations of the fifth transition metal,
wherein M₁₂ comprises nothing or at least one additional cation different from M₇, M₈, M₉, M₁₀, and M₁₁,
wherein the second oxide has a second phase structure, and
wherein each of the first transition metal, the second transition metal, the third transition metal, the fourth transition metal, and the fifth transition metal are different transition metals.

In one embodiment of the composition, the first phase structure includes oxygen vacancies. In one embodiment of the composition, the second phase structure includes oxygen vacancies.

In one embodiment of the composition, the first transition metal is manganese, the second transition metal is iron, the third transition metal is cobalt, the fourth transition metal is nickel, and the fifth transition metal is copper.

In one embodiment of the composition, x is in a range of 0.01 to 2.99. In another embodiment of the composition, x is in a range of 0.01 to 2.0. In another embodiment of the composition, x is in a range of 0.01 to 1.5. In another embodiment of the composition, x is in a range of 0.01 to 1.0. In another embodiment of the composition, x is in a range of 0.01 to 0.45.

In one embodiment of the composition, y is in a range of 0.01 to 1.99. In another embodiment of the composition, y is in a range of 0.01 to 1.5. In another embodiment of the composition, y is in a range of 0.01 to 1.0. In another embodiment of the composition, y is in a range of 0.01 to 0.3.

In one embodiment of the composition, the first phase structure is a spinel phase structure. In one embodiment of the composition, the second phase structure is a rock salt phase structure.

In one embodiment of the composition, at least one of M₁, M₂, M₃, M₄, and M₅ includes cations having different oxidation states. In one embodiment of the composition, at least one of M₇, M₈, M₉, M₁₀, and M₁₁ includes cations having different oxidation states.

In one embodiment of the composition, a first phase percentage of the first phase structure in the composition is greater than a second phase percentage of the second phase structure in the composition.

In one embodiment of the composition, at least of portion of the cations in M₁, M₂, M₃, M₄, and M₅ are substituted by lithium cations. In one embodiment of the composition, at least a portion of the cations of M₇, M₈, M₉, M₁₀, and M₁₁ are substituted by lithium cations. In one embodiment of the composition, the composition is charge neutral.

In one embodiment of the composition, M₁, M₂, M₃, M₄, and M₅ are present in an equimolar ratio. In one embodiment of the composition, M₇, M₈, M₉, M₁₀, and M₁₁ are present in an equimolar ratio.

In one embodiment of the composition, the composition has a lithium storage capacity greater than 500 mAh g⁻¹ at a current density of 100 mA g⁻¹. In another embodiment of the composition, the composition has a lithium storage capacity greater than 1000 mAh g⁻¹ at a current density of 100 mA g⁻¹.

In one embodiment of the composition, the ceramic material comprises nanoparticles. In one embodiment of the composition, the nanoparticles have a size in a range of 10-200 nanometers. In another embodiment of the composition, the nanoparticles have a size in a range of 50-200 nanometers.

In one embodiment of the composition, the composition further comprises: (b) a conductive additive. In one embodiment of the composition, the composition further comprises: (c) a binder.

In one embodiment of the composition, the composition includes: 50 wt. % to 90 wt. % of the ceramic material based on a total weight of the composition, 5 wt. % to 35 wt. % of the conductive additive based on the total weight of the composition, and 1 wt. % to 20 wt. % of the binder based on the total weight of the composition.

In one embodiment of the composition, M₆ comprises nothing. In one embodiment of the composition, M₁ and M₇ comprise Mn²⁺ and Mn³⁺ cations. In one embodiment of the composition, M₂ and M₈ comprise Fe²⁺ and Fe³⁺ cations. In one embodiment of the composition, M₃ and M₉ comprise Co²⁺ and Co³⁺ cations. In one embodiment of the composition, M₄ and M₁₀ comprise Ni²⁺ and Ni³⁺ cations. In one embodiment of the composition, M₅ and M₁₁ comprise Cu¹⁺ and Cu²⁺ cations.

The anode 118 of the electrochemical cell 110 may include a conductive additive, such as graphite, carbon black, acetylene black, Ketjen black, channel black, furnace black, lamp black, thermal black, conductive fibers, metallic powders, conductive whiskers, conductive metal oxides, and mixtures thereof. The anode 118 may optionally include a binder. Non-limiting examples of the binder include: poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, styrene-butadiene rubber, acrylonitrile-butadiene rubber, polyethylene, polypropylene, ethylene-propylene-diene terpolymers (EPDM), cellulose, carboxymethylcellulose, starch, hydroxypropylcellulose, and mixtures thereof.

In this embodiment, a suitable active material for the cathode 114 of the electrochemical cell 110 is one or more lithium host materials, or porous carbon (for a lithium air battery), or a sulfur containing material (for a lithium sulfur battery). The lithium host materials may be selected from lithium metal oxides wherein the metal is one or more of aluminum, cobalt, iron, manganese, nickel, vanadium, lithium-containing phosphates having a general formula LiMPO₄ wherein M is one or more of cobalt, iron, manganese, and nickel. In one embodiment, the lithium host material is selected from lithium cobalt oxide, lithium nickel manganese cobalt oxide, and lithium manganese oxide.

In another embodiment of the electrochemical cell 110, a suitable active material for the cathode 114 of the electrochemical cell 110 is a composition comprising:
(a) a ceramic material including:
   (i) a first oxide having a formula (I):

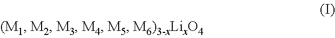

wherein x is in a range of 0 to less than 3,
wherein M₁ comprises cations of a first transition metal,
wherein M₂ comprises cations of a second transition metal,
wherein M₃ comprises cations of a third transition metal,
wherein M₄ comprises cations of a fourth transition metal,
wherein M₅ comprises cations of a fifth transition metal,
wherein M₆ comprises nothing or at least one additional cation different from M₁, M₂, M₃, M₄, and M₅,
wherein the first oxide has a first phase structure, and
(ii) a second oxide having a formula (II):

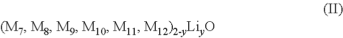

wherein y is in a range of 0 to less than 2,
wherein M₇ comprises cations of the first transition metal,
wherein M₈ comprises cations of the second transition metal,
wherein M₉ comprises cations of the third transition metal,
wherein M₁₀ comprises cations of the fourth transition metal,
wherein M₁₁ comprises cations of the fifth transition metal,
wherein M₁₂ comprises nothing or at least one additional cation different from M₇, M₈, M₉, M₁₀, and M₁₁,
wherein the second oxide has a second phase structure, and
wherein each of the first transition metal, the second transition metal, the third transition metal, the fourth transition metal, and the fifth transition metal are different transition metals.

In one embodiment of the composition, the first phase structure includes oxygen vacancies. In one embodiment of the composition, the second phase structure includes oxygen vacancies.

In one embodiment of the composition, the first transition metal is manganese, the second transition metal is iron, the third transition metal is cobalt, the fourth transition metal is nickel, and the fifth transition metal is copper.

In one embodiment of the composition, x is in a range of 0.01 to 2.99. In another embodiment of the composition, x is in a range of 0.01 to 2.0. In another embodiment of the composition, x is in a range of 0.01 to 1.5. In another embodiment of the composition, x is in a range of 0.01 to 1.0. In another embodiment of the composition, x is in a range of 0.01 to 0.45.

In one embodiment of the composition, y is in a range of 0.01 to 1.99. In another embodiment of the composition, y is in a range of 0.01 to 1.5. In another embodiment of the composition, y is in a range of 0.01 to 1.0. In another embodiment of the composition, y is in a range of 0.01 to 0.3.

In one embodiment of the composition, the first phase structure is a spinel phase structure. In one embodiment of the composition, the second phase structure is a rock salt phase structure.

In one embodiment of the composition, at least one of M₁, M₂, M₃, M₄, and M₅ includes cations having different oxidation states. In one embodiment of the composition, at least one of M₇, M₈, M₉, M₁₀, and M₁₁ includes cations having different oxidation states.

In one embodiment of the composition, a first phase percentage of the first phase structure in the composition is greater than a second phase percentage of the second phase structure in the composition.

In one embodiment of the composition, at least of portion of the cations in M₁, M₂, M₃, M₄, and M₅ are substituted by lithium cations. In one embodiment of the composition, at least a portion of the cations of M₇, M₈, M₉, M₁₀, and M₁₁ are substituted by lithium cations. In one embodiment of the composition, the composition is charge neutral.

In one embodiment of the composition, M₁, M₂, M₃, M₄, and M₅ are present in an equimolar ratio. In one embodiment of the composition, M₇, M₈, M₉, M₁₀, and M₁₁ are present in an equimolar ratio.

In one embodiment of the composition, the composition has a lithium storage capacity greater than 500 mAh g⁻¹ at a current density of 100 mA g⁻¹. In another embodiment of the composition, the composition has a lithium storage capacity greater than 1000 mAh g⁻¹ at a current density of 100 mA g⁻¹.

In one embodiment of the composition, the ceramic material comprises nanoparticles. In one embodiment of the composition, the nanoparticles have a size in a range of 10-200 nanometers. In another embodiment of the composition, the nanoparticles have a size in a range of 50-200 nanometers.

In one embodiment of the composition, the composition further comprises:
(b) a conductive additive. In one embodiment of the composition, the composition further comprises: (c) a binder.

In one embodiment of the composition, the composition includes: 50 wt. % to 90 wt. % of the ceramic material based on a total weight of the composition, 5 wt. % to 35 wt. % of the conductive additive based on the total weight of the composition, and 1 wt. % to 20 wt. % of the binder based on the total weight of the composition.

In one embodiment of the composition, M₆ comprises nothing. In one embodiment of the composition, M₁ and M₇ comprise Mn²⁺ and Mn³⁺ cations. In one embodiment of the composition, M₂ and M₈ comprise Fe²⁺ and Fe³⁺ cations. In one embodiment of the composition, M₃ and M₉ comprise Co²⁺ and Co³⁺ cations. In one embodiment of the composition, M₄ and M₁₀ comprise Ni²⁺ and Ni³⁺ cations. In one embodiment of the composition, M₅ and M₁₁ comprise Cu¹⁺ and Cu²⁺ cations.

The cathode 114 of the electrochemical cell 110 may include a conductive additive, such as graphite, carbon black, acetylene black, Ketjen black, channel black, furnace black, lamp black, thermal black, conductive fibers, metallic powders, conductive whiskers, conductive metal oxides, and mixtures thereof. The cathode 114 may optionally include a binder. Non-limiting examples of the binder include: poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, styrene-butadiene rubber, acrylonitrile-butadiene rubber, polyethylene, polypropylene, ethylene-propylene-diene terpolymers (EPDM), cellulose, carboxymethylcellulose, starch, hydroxypropylcellulose, and mixtures thereof.

In this embodiment, a suitable active material for the anode 188 of the electrochemical cell 110 is an active material selected from the group consisting of graphite, lithium titanate, hard carbon, tin/cobalt alloy, and silicon carbon. In another embodiment, the anode 188 of the electrochemical cell 110 consists essentially of lithium metal.

An example electrolyte 116 of the electrochemical cell 110 comprises a lithium compound in an organic solvent. The lithium compound may be selected from LiPF₆, LiBF_{4,} LiClO₄, lithium bis(fluorosulfonyl)imide (LiFSI), LiN(CF₃SO₂)₂ (LiTFSI), and LiCF₃SO₃ (LiTf). The organic solvent may be selected from carbonate based solvents, ether based solvents, ionic liquids, and mixtures thereof. The carbonate based solvent may be selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, and butylene carbonate; and the ether based solvent may be selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane.

During normal operation, the principal functions of the separator 115 are to prevent electronic conduction (i.e., shorts or direct contact) between the anode and cathode while permitting ionic conduction via the electrolyte. A suitable material for the separator 115 of the electrochemical cell 110 is porous polypropylene, porous polyethylene, or blends or layers thereof.

Alternatively, the separator 115 and the liquid electrolyte 116 of the electrochemical cell 110 may be replaced with a solid electrolyte material. In non-limiting example solid electrolyte materials, the solid electrolyte material comprises a material selected from the group consisting of substituted or unsubstituted lithium lanthanum zirconium oxides (LLZO), Li₁₀GeP₂S₁₂ (LGPS), Li_{0.33}La_{0.56}TiO₃ (LLTO), Li₂PO₂N (LiPON), and lithium polysulfides (LiPS).

The present invention also provides an electrochemical cell including an anode comprising a composition of the present invention; a cathode comprising a lithium host material; and an electrolyte configured to facilitate the transfer of ions between the anode and the cathode.

In one embodiment of the electrochemical cell, the anode further comprises a conductive additive. In one embodiment of the electrochemical cell, the anode further comprises a binder.

In one embodiment of the electrochemical cell, the composition includes: 50 wt. % to 90 wt. % of the ceramic material based on a total weight of the composition, 5 wt. % to 35 wt. % of the conductive additive based on the total weight of the composition, and 1 wt. % to 20 wt. % of the binder based on the total weight of the composition. In another embodiment of the electrochemical cell, the composition includes: 60 wt. % to 80 wt. % of the ceramic material based on a total weight of the composition, 10 wt. % to 30 wt. % of the conductive additive based on the total weight of the composition, and 5 wt. % to 15 wt. % of the binder based on the total weight of the composition. In one embodiment of the electrochemical cell, the conductive additive is selected from the group consisting of graphite, carbon black, acetylene black, Ketjen black, channel black, furnace black, lamp black, thermal black, conductive fibers, metallic powders, conductive whiskers, conductive metal oxides, and mixtures thereof, and the binder is selected from the group consisting of carboxymethylcellulose, styrene-butadiene rubber, poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, acrylonitrile-butadiene rubber, polyethylene, polypropylene, ethylene-propylene-diene terpolymers (EPDM), cellulose, starch, hydroxypropylcellulose, and mixtures thereof.

In one embodiment of the electrochemical cell, the cathode comprises a lithium host material selected from lithium metal oxides wherein the metal is one or more of aluminum, cobalt, iron, manganese, nickel, vanadium, and lithium-containing phosphates having a general formula LiMPO₄, wherein M is one or more of cobalt, iron, manganese, and nickel.

In one embodiment of the electrochemical cell, the electrolyte is a liquid electrolyte comprising a lithium compound in an organic solvent. In one embodiment of the electrochemical cell, the electrolyte is a solid-state electrolyte comprising a material selected from the group consisting of substituted or unsubstituted lithium lanthanum zirconium oxides (LLZO), Li₁₀GeP₂S₁₂ (LGPS), Li_{0.33}La_{0.56}TiO₃ (LLTO), Li₂PO₂N (LiPON), and lithium polysulfides (LiPS).

In one embodiment, the electrochemical cell delivers a discharge capacity of at least 400 mAh g⁻¹ at a current density of 3000 mA g⁻¹. In another embodiment, the electrochemical cell delivers a specific capacity of at least 500 mAh g⁻¹ and a capacity retention rate of at least 50% after 1000 cycles at a current density of 2000 mAh g⁻¹.

The present invention also provides an electrochemical cell including an anode; a cathode comprising a composition of the present invention; and an electrolyte configured to facilitate the transfer of ions between the anode and the cathode.

In one embodiment of the electrochemical cell, the cathode further comprises a conductive additive. In one embodiment of the electrochemical cell, the cathode further comprises a binder.

In one embodiment of the electrochemical cell, the composition includes: 50 wt. % to 90 wt. % of the ceramic material based on a total weight of the composition, 5 wt. % to 35 wt. % of the conductive additive based on the total weight of the composition, and 1 wt. % to 20 wt. % of the binder based on the total weight of the composition. In another embodiment of the electrochemical cell, the composition includes: 60 wt. % to 80 wt. % of the ceramic material based on a total weight of the composition, 10 wt. % to 30 wt. % of the conductive additive based on the total weight of the composition, and 5 wt. % to 15 wt. % of the binder based on the total weight of the composition. In one embodiment of the electrochemical cell, the conductive additive is selected from the group consisting of graphite, carbon black, acetylene black, Ketjen black, channel black, furnace black, lamp black, thermal black, conductive fibers, metallic powders, conductive whiskers, conductive metal oxides, and mixtures thereof, and the binder is selected from the group consisting of carboxymethylcellulose, styrene-butadiene rubber, poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, acrylonitrile-butadiene rubber, polyethylene, polypropylene, ethylene-propylene-diene terpolymers (EPDM), cellulose, starch, hydroxypropylcellulose, and mixtures thereof.

In this embodiment, a suitable active material for the anode of the electrochemical cell is an active material selected from the group consisting of graphite, lithium titanate, hard carbon, tin/cobalt alloy, and silicon carbon. In another embodiment, the anode of the electrochemical cell consists essentially of lithium metal.

In one embodiment of the electrochemical cell, the electrolyte is a liquid electrolyte comprising a lithium compound in an organic solvent. In one embodiment of the electrochemical cell, the electrolyte is a solid-state electrolyte comprising a material selected from the group consisting of substituted or unsubstituted lithium lanthanum zirconium oxides (LLZO), Li₁₀GeP₂S₁₂ (LGPS), Li_{0.33}La_{0.56}TiO₃ (LLTO), Li₂PO₂N (LiPON), and lithium polysulfides (LiPS).

In one embodiment, the electrochemical cell delivers a discharge capacity of at least 400 mAh g⁻¹ at a current density of 3000 mA g⁻¹. In another embodiment, the electrochemical cell delivers a specific capacity of at least 500 mAh g⁻¹ and a capacity retention rate of at least 50% after 1000 cycles at a current density of 2000 mAh g⁻¹.

The present invention also provides a method for synthesizing a high entropy oxide composition. The method comprises: (a) providing a solution of a fuel and an oxidant, wherein the fuel comprises glycine, urea, citric acid, or a mixture thereof, and wherein the oxidant comprises: a first oxidant including a first metal nitrate and/or a first metal nitrate hydrate, a second oxidant including a second metal nitrate and/or a second metal nitrate hydrate, a third oxidant including a third metal nitrate and/or a third metal nitrate hydrate, a fourth oxidant including a fourth metal nitrate and/or a fourth metal nitrate hydrate, a fifth oxidant including a fifth metal nitrate and/or a fifth nitrate metal hydrate, and a sixth oxidant including lithium nitrate and/or a lithium nitrate hydrate; and (b) increasing a temperature of the solution of the oxidant and the fuel such that the first oxidant, the second oxidant, the third oxidant, the fourth oxidant, the fifth oxidant, and the sixth oxidant thermally decompose, yielding nanoparticles of a high entropy oxide composition.

In one embodiment of the method, a fuel-to-oxidant stoichiometric ratio is less than 1.0. In another embodiment of the method, a fuel-to-oxidant stoichiometric ratio is in a range of 0.8 to 0.99. In another embodiment of the method, a fuel-to-oxidant stoichiometric ratio is in a range of 0.9 to 0.99.

In one embodiment of the method, step (b) comprises: a one-step combustion synthesis. In one embodiment of the method, the solution includes a solvent, and in step (b), the solvent evaporates creating a gel that spontaneously ignites. In one embodiment of the method, the solvent is selected from the group consisting of water, ethanol, acetone, and mixtures thereof. In one embodiment of the method, the fuel comprises glycine.

In one embodiment of the method, the first oxidant, the second oxidant, the third oxidant, the fourth oxidant, and the fifth oxidant are present in the oxidant in equimolar amounts. In one embodiment of the method, the first oxidant includes a first transition metal nitrate and/or a first transition metal nitrate hydrate, the second oxidant includes a second transition metal nitrate and/or a second transition metal nitrate hydrate, the third oxidant includes a third transition metal nitrate and/or a third transition metal nitrate hydrate, the fourth oxidant includes a fourth transition metal nitrate and/or a fourth transition metal nitrate hydrate, and the fifth oxidant includes a fifth transition metal nitrate and/or a fifth transition metal nitrate hydrate, and each of the first transition metal, the second transition metal, the third transition metal, the fourth transition metal, and the fifth transition metal are different transition metals.

In one embodiment of the method, the first oxidant includes manganese nitrate and/or a manganese nitrate hydrate, the second oxidant includes iron nitrate and/or an iron nitrate hydrate, the third oxidant includes cobalt nitrate and/or a cobalt nitrate hydrate, the fourth oxidant includes nickel nitrate and/or a nickel nitrate hydrate, and the fifth oxidant includes copper nitrate and/or a copper nitrate hydrate.

In one embodiment of the method, the high entropy oxide composition comprises a first oxide having a first phase structure and a second oxide having a second phase structure. In one embodiment of the method, a first phase percentage of the first phase structure in the composition is greater than a second phase percentage of the second phase structure in the composition. In one embodiment of the method, the first phase structure includes oxygen vacancies, and the second phase structure includes oxygen vacancies. In one embodiment of the method, the first phase structure is a spinel phase structure. In one embodiment of the method, the second phase structure is a rock salt phase structure.

A non-limiting example embodiment of the present invention utilizes the nitrates of five transition metals namely, Mn, Fe, Co, Ni, and Cu as precursors, with glycine serving as both fuel and chelating agent. Additionally, a method of the present invention employs lithium nitrate to integrate lithium into the HEO materials, achieving samples that predominantly exhibit a spinel phase, (MnFeCoNiCu)₃₋ₓLiₓO₄, wherein x is in a range of 0 to less than 3, along with a minor rock-salt phase, (MnFeCoNiCu)_{2-y}Li_{y}O wherein y is in a range of 0 to less than 2. In these phases, a small amount of lithium is incorporated to increase oxygen vacancies through charge compensation mechanisms. Furthermore, a fuel-lean condition during combustion synthesis leads to a higher oxidation state and a more homogeneous elemental distribution in the composites compared to those with stoichiometric ratios. This improved synthesis approach enables superior rate capability in the synthesized material, delivering a high capacity of 763.93 mAh g⁻¹ at a current density of 0.1 A g⁻¹ and 478.2 mAh g⁻¹ at a current density of 3 A g⁻¹, corresponding to 62.6% capacity retention rate. Moreover, the synthesized material maintains a capacity of 282.88 mAh g⁻¹ after 1000 cycles at a current density of 2 A g⁻¹.

### EXAMPLE

The following Example has been presented in order to further illustrate the invention and is not intended to limit the invention in any way. The statements provided in the Example are presented without being bound by theory.

### 1. Overview of the Example

Oxygen vacancies can raise not only the ion diffusion kinetics by providing percolating channel but also the electron conductivity by serving as charge carrier. Furthermore, it has been demonstrated that the existence of secondary phase in HEOs can also promote redox kinetics by introducing phase boundaries. The proposed HEO composites are designed by an ultrafast one-step combustion synthesis, containing abundant oxygen vacancies and phase boundaries which can synergistically boost the conductivity of the material. During combustion synthesis, a small amount of lithium ions is incorporated in the HEOs to increase oxygen vacancies through a charge compensation mechanism and fuel-lean condition was exploited where fuel acts as a reductive agent. As a result, dual-phase defect-rich HEOs with superior ionic and electronic conductivity, as well as a higher oxidation state which leads to higher specific capacity, could be successfully achieved. HEO-D_{R}FL exhibited high lithium storage capacity (1031 mAh g⁻¹ at a current density of 100 mA g⁻¹) and outstanding rate capability (478.2 mAh g⁻¹ at a current density of 3000 mA g⁻¹).

### 2. Experimental Methods

### Preparation of Composite Anodes

Defect-rich high entropy oxides in fuel-lean condition, defect-rich high entropy oxides, and high entropy oxide nanoparticles (denoted as HEO-D_{R}FL, HEO-D_{R} and HEO-NP, respectively) were synthesized via a facile one-step combustion synthesis. Manganese(II) nitrate tetrahydrate (Mn(NO₃)₂)·4H₂O), iron(III) nitrate nonahydrate (Fe(NO₃)₃·9H₂O), cobalt(II) nitrate hexahydrate (Co(NO₃)₂·6H₂O), nickel(II) nitrate hexahydrate (Ni(NO₃)₂·6H₂O), copper(II) nitrate trihydrate (Cu(NO₃)₂·3H₂O), lithium nitrate (LiNO₃), and glycine (NH₂CH₂COOH) were purchased from Sigma-Aldrich. For the synthesis of HEO-D_{R}FL, equimolar (Mn, Fe, Co, Ni, Cu) nitrates (0.18 mol each) and 0.1 mol of LiNO₃ as oxidants, and NH₂CH₂COOH with a fuel-to-oxidizer ratio (φ) of 0.95 were first dissolved in 20 ml de-ionized (DI) water and stirred magnetically to form a homogenous solution. Subsequently, the dissolved mixtures were placed on the hot plate at 300° C. After a few minutes, when the solvent was completely evaporated, the gel spontaneously ignited. The entire combustion process lasted for only a few seconds and HEO-D_{R}FL powder could be finally obtained. For comparison, HEO-D_{R} and HEO-NP were synthesized at the same procedure except that the combustion synthesis was under fuel stoichiometric condition (φ=1). Additionally, LiNO₃ was not introduced for the synthesis of HEO-NP.

### Materials Characterization

Crystalline structure was determined by X-ray diffraction (Smartlab, Rigaku) with a Cu Ka radiation source at 40 kV and 44 mA. The element components and oxidation state of the samples were analyzed using an X-ray Photoelectron Spectrometer (XPS, Kratos Axis Ultra). The morphology was investigated by scanning electron microscopy (SEM, TESCAN MIRA3) and transmission electron microscopy (TEM, Talos F200X G2). High Resolution transmission electron microscope (HRTEM) and selected area electron diffraction (SAED) were used to study the microstructural information of the samples. STEM-EDS and EELS mapping were conducted to analyze elemental distribution.

### Electrode Preparation

The electrode slurry was composed of 70 wt. % active material (70 wt. %) and Super P conductive carbon black (20 wt. %) were ground together evenly, then mixed with 10 wt. % CMC/SBR (carboxymethyl cellulose/styrene-butadiene rubber) binder in deionized water to form a slurry (2000 rpm, 20 minutes). The slurry was cast onto Cu foil current collector with a doctor blade and dried under vacuum at 80° C. overnight. Subsequently, the dried copper foil was cut into a disc with a diameter of 15 mm. The mass loading of active material was around 1 mg cm⁻². Li foil was used as the counter electrode and the separator was 20-μm thick polypropylene membrane (Celgard 2400). The electrolyte used was 1.0 M LiPF₆ in ethylene carbonate/diethyl carbonate (1:1 vol). The CR2032 coin cells were assembled in a glove box filled with argon gas where both the oxygen and moisture content levels were below 0.1 ppm.

### Electrochemical Measurements

Cyclic voltammetry (CV) was performed between 0.01-3.0 V (vs. Li/Li⁺) with a sweep rate of 0.1 mV s⁻¹. Electrochemical impedance spectroscopy (EIS) measurements were carried out with frequencies ranging from 10⁻² to 10⁶ Hz. The charge-discharge measurements were conducted by a multichannel battery test system within a range of 0.01-3.0 V (vs. Li/Li⁺) for half-cell. The galvanostatic intermittent titration technique (GITT) was applied to test the Li ion diffusion coefficients in the electrodes during charge and discharge. Postmortem analyses on the electrode materials were also carried out. The cycled batteries were disassembled and cleaned with dimethyl carbonate solvent, followed by drying for 24 hours in the glove box.

### Computational Details

All DFT-based calculations were performed using the Cambridge Serial Total Energy Package (CASTEP) code. A generalized-gradient approximation (GGA) functional proposed of Perdew, Burke, and Ernzerhof for solids (PBEsol) was used for the exchange-correlation potential. We used a cutoff energy of 500 eV for the plane wave basis set and the Brillouin zone was sampled using 3×3×3 Monkhorst-Pack k-point meshes. The convergence criterion of geometry optimization loop was set to less than 10⁻⁵ eV (per atom) for total energy change and less than 0.03 eV Å⁻¹ for the residual forces on the atoms and maximum displacement force of 0.001 Å were used. For the defect system, an oxygen vacancy (Vₒ) and two Li-dopings (2Li-doped) are introduced in the perfect crystal of spinel and rock-salt structures, respectively. Two cations in 8a or 16d of HEO primitive cells are substituted by Li atoms while oxygen vacancy was obtained by removing one O atom for the cell. The convergence criterion of geometric relaxation loops was set to less than 10⁻⁵ eV/atom for total energy change and less than −0.01 eV/Å for the norms of all the forces. Also, we used a DFT+U approach to represent the on-site Coulomb repulsive potentials of localized d orbitals of transition metal atoms. The Hubbard U values for Mn, Fe, Co, Ni, Cu are set as 4, 5, 3.5, 6, 4 eV, respectively.

HEO-D_{R}FL with abundant oxygen vacancies and phase boundaries was synthesized by a simple one-step combustion method. Briefly, five different metal nitrates with equimolar cation composition (M=Mn, Fe, Co, Ni, Cu) are chosen as oxidant with a proper amount of lithium nitrate added, which enables introduction of defects, such as oxygen vacancies. Meanwhile, glycine serves not only as fuel but also chelating agent. To achieve a higher content of spinel phases in higher oxidation state, lean conditions of glycine were utilized. FIG. 1 panel a displays the detailed morphology of the resulting sample and nanostructures shows uniformly spread nanoparticles (70-150 nm) on the porous framework. For comparison, HEO-D_{R} and HEO-NP are also prepared, and both show similar morphology but a slightly bigger particle size of 100-200 nm (FIG. 1 panel b).

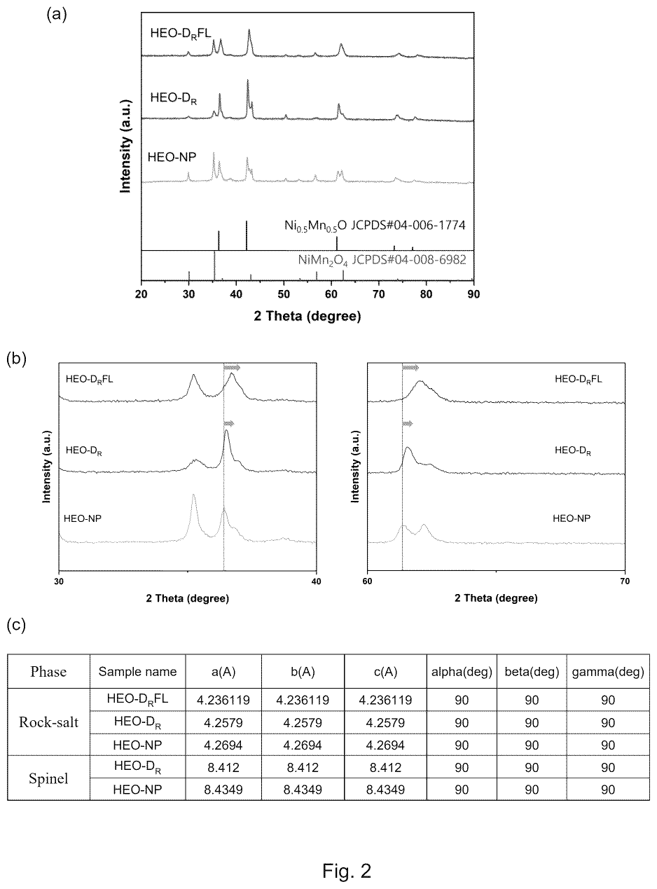

X-ray diffraction (XRD) patterns presented in FIG. 2 confirm that all three samples form a spinel phase and rock-salt phase as a secondary phase. No additional peaks including Li₂O phase are observed, which proves successful partial substitution of cations in HEOs by Li⁺ ion. As displayed in FIG. 2 panel b, the diffraction peaks of the rock-salt phase of HEO-D_{R} and HEO-D_{R}FL, and the spinel phase of HEO-D_{R}, are shifted to higher 2 theta degrees compared to those of HEO-NP, indicating a decrease of the lattice parameters. The values of the lattice parameters from Rietveld refinement analysis are also shown in FIG. 2 panel c with further details. This confirms that Li doping leads to unit cell shrinkage, although the ionic radius of Li⁺ is larger than the ionic radius of other divalent and trivalent cations constituting the system. Therefore, it can be found that charge compensation mechanism occurs upon substitution of cations in HEOs by Li⁺. The mechanism may involve the formation of oxygen vacancies or 3+ cations formation.

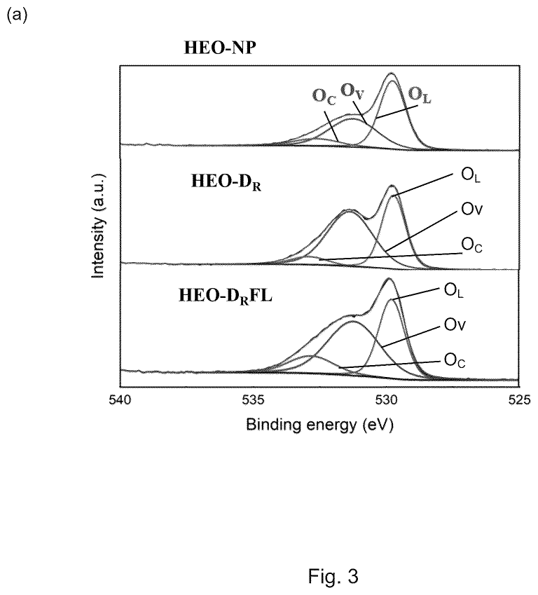

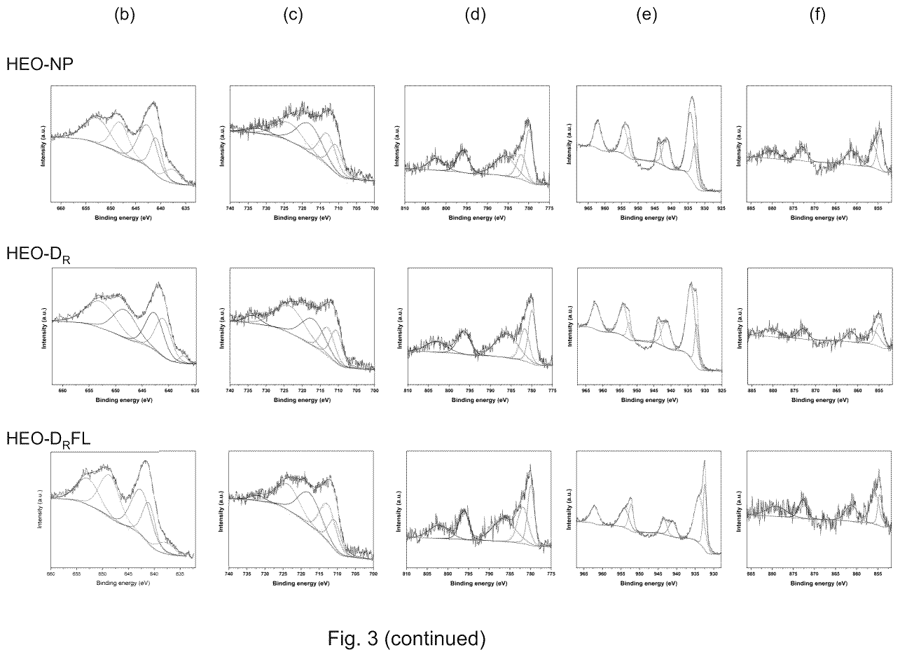

To determine valence distribution of each element and charge compensation mechanism, X-ray photoelectron spectroscopy (XPS) analysis was carried out as shown in FIG. 3. In FIG. 3 panel a, the binding energy at 529.76 eV, 531.26 eV, 532.81 eV in the O 1s spectra represents lattice oxygen (O_{L}), oxygen vacancy (Oᵥ) and adsorbed oxygen (O_{c}), respectively. Obviously, the peak intensity of HEO-D_{R}, HEO-D_{R}FL at 531.26 eV is higher than that of HEO-NP, revealing the formation of higher relative content of oxygen vacancies for lithium doped samples.

The XPS spectra of the other cation elements demonstrated multivalent states. In the Fe 2p spectra, the peaks at 710.73 eV (Fe 2p_{3/2}) and 712.67 eV (Fe 2p_{3/2}) are assigned to the Fe²⁺ and Fe³⁺ oxidation state, respectively. The Fe²⁺/Fe³⁺ ratios are 42.4/54.6, 50.2/49.8 and 37.7/62.3 for HEO-NP, HEO-D_{R}, and HEO-D_{R}FL. The 723.68 eV peak is attributed to the Fe 2p_{1/2} and both the Co_{LMM} auger peak overlapped with the satellite peaks, and the satellite peak are found at 717.78 eV and 732.01 eV, respectively. The Mn 2p spectra show the two main 2p_{3/2} peaks at 641.04 and 642.51 eV, which are fitted into Mn²⁺ and Mn³⁺, respectively. The calculated Mn²⁺/Mn³⁺ ratios are 36.2/63.8, 47.7/52.3 and 37.4/62.6 for HEO-NP, HEO-D_{R} and HEO-D_{R}FL. The Mn 2p_{1/2} peak is located at 652.83 eV. The Auger peak and satellite peak are found at 637.81 and 648.64 eV, respectively. In the XPS Co spectra, the peaks at 781.85 eV (Co 2p_{3/2}) and 779.97 eV (Co 2p_{3/2}) are associated with Co²⁺ and Co³⁺, respectively. The Co²⁺/Co³⁺ ratios of HEO-NP, HEO-D_{R} and HEO-D_{R}FL are 37.2/62.8, 42.8/57.2 and 48/52. The Co 2p_{1/2} orbital peak is found at 796.14 eV, while two satellite peaks are seen at 732.01 and 786.41 eV. In the Cu 2p spectra, two peaks at 932.40 and 934.14 eV are attributed to the Cu¹⁺ and Cu²⁺, respectively. The Cu¹⁺/Cu²⁺ ratios in HEO-NP, HEO-D_{R} and HEO-D_{R}FL are 32.4/67.6, 21.7/78.3 and 35.3/64.7. The peaks at 952.36 and 954.10 eV correspond to the Cu 2p_{1/2} and two peaks at 943.74 and 962.11 eV are the satellite peaks. Two peaks at 854.47 and 856.10 eV in the Ni 2p_{3/2} spectra are attributed to the Ni²⁺ and Ni³⁺, respectively. The Ni²⁺/Ni³⁺ ratios of HEO-NP, HEO-D_{R} and HEO-D_{R}FL are 58/42, 51.3/48.7 and 52.4/47.6. The Ni 2p_{1/2} peak is located at 872.91 eV, while two satellite peaks are observed at 861.07 and 880.09 eV.

The above XPS results show that HEO-NP has a higher content of trivalent ions compared to HEO-D_{R}, due to the higher proportion of spinel phase. However, HEO-D_{R}, which contains lithium ions with a large ionic radius and lower concentration of trivalent ions has smaller unit cell size than HEO-NP. This indicates that oxygen vacancy introduced by lithium doping plays an important role in the charge compensation process and thereby leads to unit cell shrinkage. Meanwhile, HEO-D_{R}FL has the highest concentration of trivalent ions since it is fabricated under fuel-lean conditions. Furthermore, it has the smallest volume of rock salt unit cells, which also confirms that unit cell shrinkage predominantly stems from the abundant oxygen vacancies.

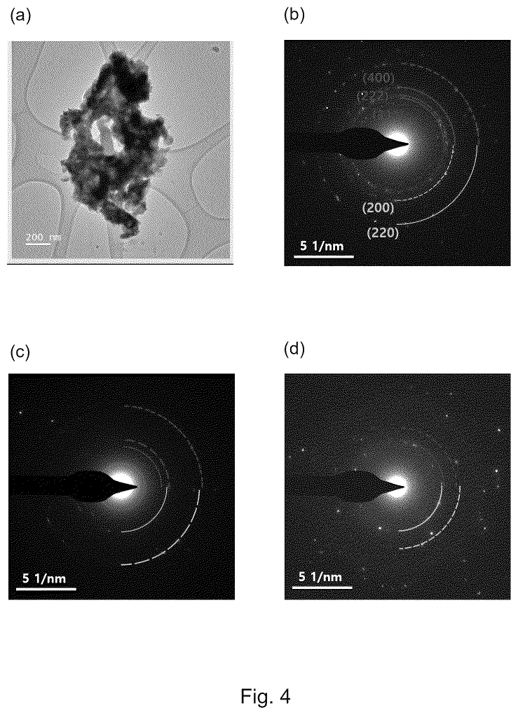

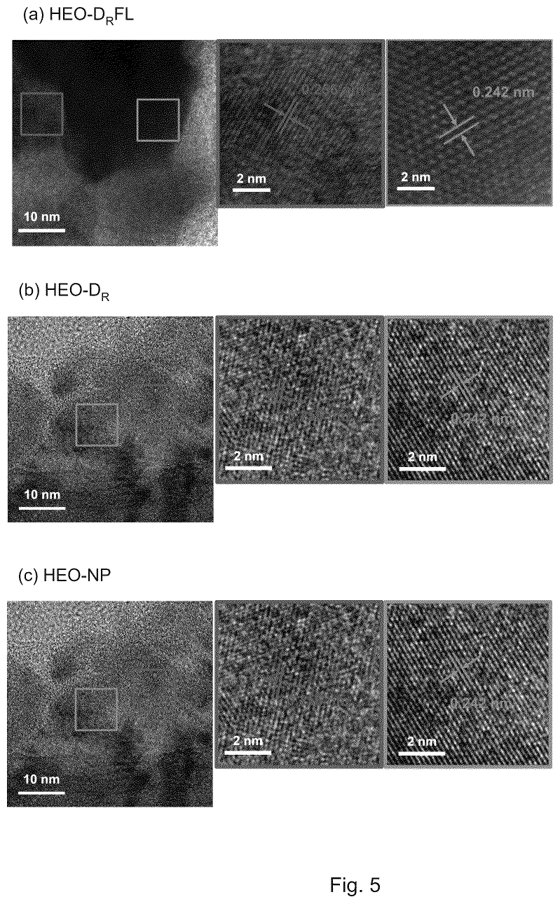

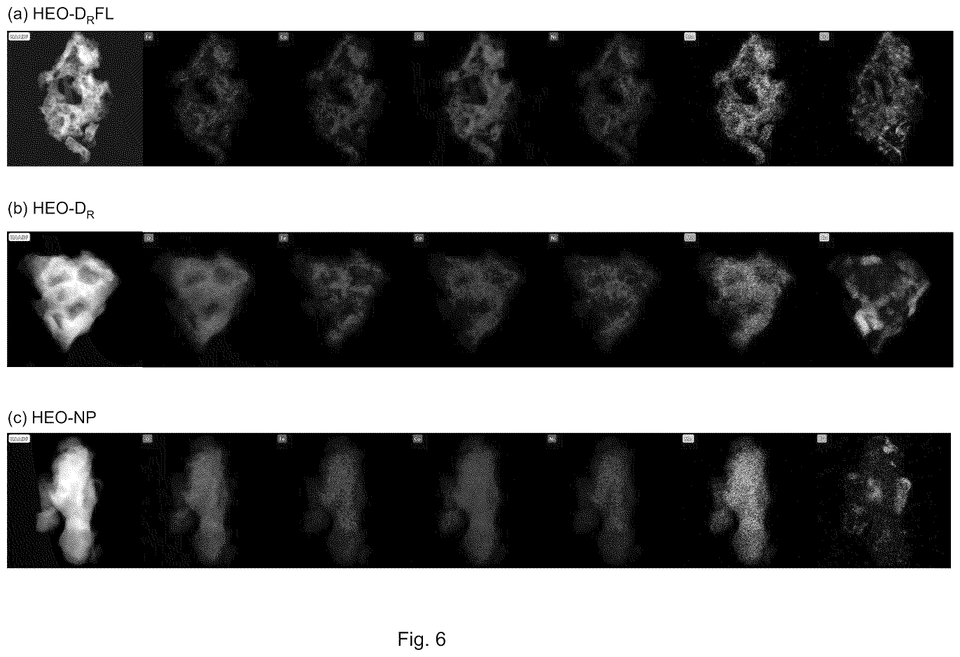

The further structure characterization of HEO-D_{R}FL examined by TEM is given in FIG. 4. The TEM image (FIG. 4 panel a) displays the structure of porous nanoparticles. Diffraction rings in selected area electron diffraction (SAED) patterns show the coexistence of spinel and rock salt phase structures. In high resolution TEM (HRTEM) images (FIG. 5), the formation of phase boundaries and two phases are clearly observed, where lattice spacings are measured to be 0.256 and 0.242 nm, corresponding to the (311) plane of spinel phase and (111) plane of rock-salt phase, respectively. Moreover, the homogeneous distribution of all the elements in HEO-D_{R}FL was demonstrated by energy dispersive spectrometry (EDS) and energy loss spectroscopy (EELS) mapping (FIG. 6 panel a). By contrast, a little segregation of copper element was detected in HEO-NP and HEO-D_{R} (FIG. 6 panel b, panel c) due to the higher reductive atmosphere condition in combustion synthesis, although the entropy values of both samples were still higher than 1.5 R, which is empirical classification of high entropy oxides. Meanwhile, it has been studied that cation species in high entropy spinel oxides have the occupational preference of tetrahedral or octahedral sites. Higher concentration of Cu²⁺ (0.73 Å) with a larger ionic radius compared to other cations in the preferred site (such as Co³⁺, Mn³⁺, Ni²⁺: 0.69, 0.67, 0.69 Å, etc.) can lead to a bigger size of the unit cell. Therefore, the reason why the XRD peak of HEO-D_{R}FL in spinel phase (FIG. 2) does not shift toward higher angles can be explained by the segregation of Cu²⁺ in HEO and HEO-DR, although it has higher concentration of oxygen vacancies.

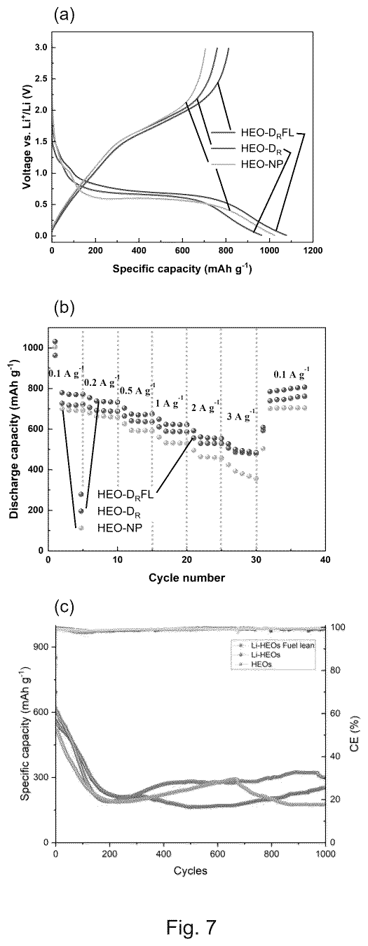

Introduction of abundant oxygen vacancies by lithium doping and phase boundaries significantly improved the electrochemical performance of HEO anodes. As shown in FIG. 7 panel a, HEO-D_{R}FL presents the highest initial specific capacity of 1031 mAh g⁻¹ and initial coulombic efficiency of 76.6%. The higher oxidation state of the structure resulting from fuel-lean synthesis condition enables the highest initial capacity. In FIG. 7 panel b, the rate capabilities were calculated. HEO-D_{R}FL delivers the discharge capacity of 478.2 mAh g⁻¹ at 3000 mA g⁻¹ and corresponding to the capacity retention rate of 62.6% compared with the discharge capacity at the 5^{th} cycle where the current rate was 100 mA g⁻¹. By comparison, the specific capacity of HEO-D_{R} and HEO-NP at 3000 mA g⁻¹ was 475.24 and 351.29 mAh g⁻¹ respectively, corresponding to 66.3 and 51% of their initial discharge capacities. Furthermore, HEO-D_{R}FL also exhibits the superior initial charge specific capacity of 566.36 mAh g⁻¹ and capacity retention rate of 50% after 1000 cycles at 2000 mAh g⁻¹, compared to 555 mAh g⁻¹ and 46.6% for HEO-D_{R}, and 444.6 mAh g⁻¹ and 34.5% for HEO-NP, respectively (FIG. 7 panel c). It confirms that HEO-D_{R}FL can have an excellent capacity retention rate due to its enhanced conductivity resulting from the phase boundaries and oxygen-vacancy-rich structures.

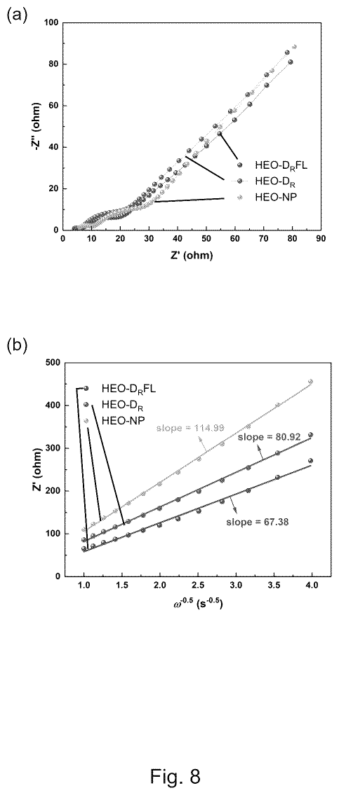

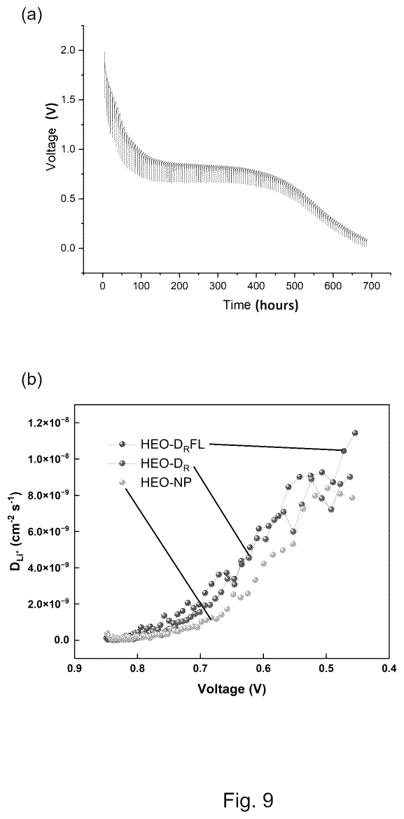

The electrochemical impedance spectroscopy (EIS) measurement data is shown in FIG. 8 panel a. Based on the relationship between Z_{Re} and w^{-1/2} in the low frequency region, the Li⁺ diffusion coefficient can be calculated. The larger the slopes between Z_{Re} and w^{-1/2}, which represents the Warburg coefficient, the smaller the diffusion coefficient of Li⁺. As shown in FIG. 8 panel b, the slope of the HEO-D_{R}FL sample has the lowest value, which means the highest lithium-ion diffusion coefficient. From the galvanostatic intermittent titration technique (GITT) measurements, it can be also observed that lithium doped samples HEO-D_{R}FL and HEO-D_{R} have higher lithium-ion diffusion coefficient than HEO-NP. (See FIG. 9).

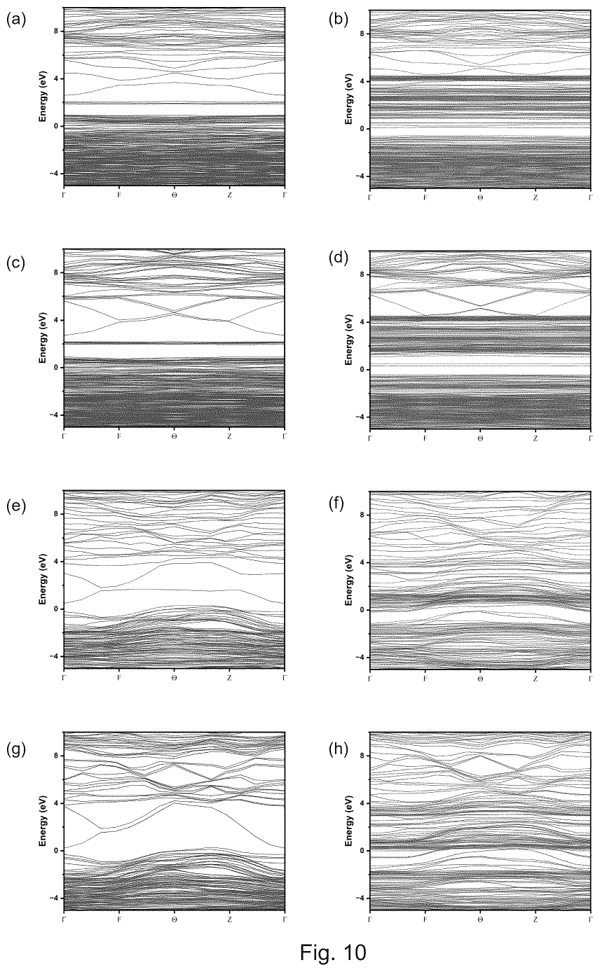

The electrical properties were simulated through first-principles calculations to understand the effect of oxygen vacancy using spinel and rock-salt structure of HEO (HEO-S and HEO-R, respectively), and spinel and rock-salt structure of HEO with oxygen vacancy (Oᵥ-HEO-S and Oᵥ-HEO-R, respectively) as the models. The calculated band structures of Oᵥ-HEO-R, HEO-R, Ov-HEO-S, HEO-S are illustrated in FIG. 10. Energy bands of Oᵥ-HEO-R and HEO-R overlapped with the Fermi energy level, showing “metallicity”. “Metallicity” does not mean that rock-salt structure HEOs are not metals but still essentially semiconductor. Meanwhile, Oᵥ-HEO-S shows smaller band gap in comparison with that of HEO-S demonstrating that introduction of oxygen vacancies induces the movement of conduction band toward the Fermi Level. This indicates that electrical conductivity can be enhanced due to the presence of oxygen vacancies.

A “combined defect engineering and phase structure design” approach via a one-step combustion synthesis was demonstrated. By introducing oxygen vacancy, and the secondary phase for phase boundaries into HEOs, the resulting composite anode, HEO-D_{R}FL exhibits an initial capacity of 1031 mAh g⁻¹ at 100 mA g⁻¹ and shows capacity retention rate of 62.6% at 3000 mAh g⁻¹. Furthermore, it delivers a specific capacity of 282.88 mAh g⁻¹ after 1000 cycles at 2000 mA g⁻¹. The highest lithium-ion diffusion coefficient of the sample is proved by EIS and GITT test. Furthermore, improved electrical conductivity is also demonstrated by DFT calculations. It is expected that the present disclosure provides a way to significantly improve the stability and conductivity of transition metal oxide-based anode materials and lower the hurdles to commercialization.

This invention unveils an innovative high-entropy oxide (HEO) electrode material featuring controlled defects that enable superior ion transport, along with a detailed synthesis route for its fabrication. HEO is an emerging new class of materials that serve as advanced anode materials for lithium-ion batteries (LIBs), offering structural stability during electrochemical reactions. However, current HEOs suffer from low intrinsic conductivity and restricted kinetics of diffusion-driven electrochemical processes, which hinders their high-performance potential at high current rates. In this invention, we demonstrate an innovative approach that combines defect engineering and phase structure design through a one-step combustion synthesis route to dramatically enhance redox kinetics. We introduced abundant oxygen vacancies and phase boundaries into HEOs by incorporating a secondary phase. In an example approach, the nitrates of five transition metals were utilized-namely, Mn, Fe, Co, Ni, and Cu-as precursors, with glycine serving as both fuel and chelating agent. The synthesized material maintains a capacity of 282.88 mAh g⁻¹ after 1000 cycles at 2 A g⁻¹.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A composition comprising:
(a) a ceramic material including:
(i) a first oxide having a formula (I): 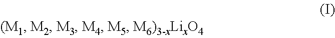
wherein x is in a range of 0 to less than 3,
wherein M₁ comprises cations of a first transition metal,
wherein M₂ comprises cations of a second transition metal,
wherein M₃ comprises cations of a third transition metal,
wherein M₄ comprises cations of a fourth transition metal,
wherein M₅ comprises cations of a fifth transition metal,
wherein M₆ comprises nothing or at least one additional cation different from M₁, M₂, M₃, M₄, and M₅,
wherein the first oxide has a first phase structure, and
(ii) a second oxide having a formula (II): 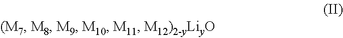
wherein y is in a range of 0 to less than 2,
wherein M₇ comprises cations of the first transition metal,
wherein M₈ comprises cations of the second transition metal,
wherein M₉ comprises cations of the third transition metal,
wherein M₁₀ comprises cations of the fourth transition metal,
wherein M₁₁ comprises cations of the fifth transition metal,
wherein M₁₂ comprises nothing or at least one additional cation different from M₇, M₈, M₉, M₁₀, and M₁₁,
wherein the second oxide has a second phase structure, and
wherein each of the first transition metal, the second transition metal, the third transition metal, the fourth transition metal, and the fifth transition metal are different transition metals.

2. The composition of claim 1 wherein:
the first phase structure includes oxygen vacancies.

3. The composition of claim 1 wherein:
the second phase structure includes oxygen vacancies.

4. The composition of claim 1 wherein:
the first transition metal is manganese,
the second transition metal is iron,
the third transition metal is cobalt,
the fourth transition metal is nickel, and
the fifth transition metal is copper.

5. The composition of claim 1 wherein:
x is in a range of 0.01 to 2.99.

6. The composition of claim 1 wherein:
y is in a range of 0.01 to 1.99.

7. The composition of claim 1 wherein:
the first phase structure is a spinel phase structure.

8. The composition of claim 1 wherein:
the second phase structure is a rock salt phase structure.

9. The composition of claim 1 wherein:
at least one of M₁, M₂, M₃, M₄, and M₅ includes cations having different oxidation states.

10. The composition of claim 1 wherein:
at least one of M₇, M₈, M₉, M₁₀, and M₁₁ includes cations having different oxidation states.

11. The composition of claim 1 wherein:
a first phase percentage of the first phase structure in the composition is greater than a second phase percentage of the second phase structure in the composition.

12. The composition of claim 1 wherein:
at least of portion of the cations in M₁, M₂, M₃, M₄, and M₅ are substituted by lithium cations.

13. The composition of claim 1 wherein:
at least a portion of the cations of M₇, M₈, M₉, M₁₀, and M₁₁ are substituted by lithium cations.

14. The composition of claim 1 wherein:
the composition is charge neutral.

15. The composition of claim 1 wherein:
the composition has a lithium storage capacity greater than 500 mAh g⁻¹ at a current density of 100 mA g⁻¹.

16. The composition of claim 1 wherein:
the ceramic material comprises nanoparticles.

17. The composition of claim 1 wherein:
M₆ comprises nothing,
M₁ and M₇ comprise Mn²⁺ and Mn³⁺ cations,
M₂ and M₈ comprise Fe²⁺ and Fe³⁺ cations,
M₃ and M₉ comprise Co²⁺ and Co³⁺ cations,
M₄ and M₁₀ comprise Ni²⁺ and Ni³⁺ cations, and
M₅ and M₁₁ comprise Cu¹⁺ and Cu²⁺ cations.

18. The composition of claim 1 wherein:
M₁, M₂, M₃, M₄, and M₅ are present in an equimolar ratio.

19. The composition of claim 1 wherein:
M₇, M₈, M₉, M₁₀, and M₁₁ are present in an equimolar ratio.

20. An electrochemical cell comprising:
an anode comprising the composition of claim 1;
a cathode comprising a lithium host material; and
an electrolyte configured to facilitate the transfer of ions between the anode and the cathode.

21. An electrochemical cell comprising:
an anode;
a cathode comprising the composition of claim 1; and
an electrolyte configured to facilitate the transfer of ions between the anode and the cathode.

22. A method for synthesizing a high entropy oxide composition, the method comprising:
(a) providing a solution of a fuel and an oxidant,
wherein the fuel comprises glycine, urea, citric acid, or a mixture thereof, and
wherein the oxidant comprises:
a first oxidant including a first metal nitrate and/or a first metal nitrate hydrate,
a second oxidant including a second metal nitrate and/or a second metal nitrate hydrate,
a third oxidant including a third metal nitrate and/or a third metal nitrate hydrate,
a fourth oxidant including a fourth metal nitrate and/or a fourth metal nitrate hydrate,
a fifth oxidant including a fifth metal nitrate and/or a fifth nitrate metal hydrate, and
a sixth oxidant including lithium nitrate and/or a lithium nitrate hydrate; and
(b) increasing a temperature of the solution of the oxidant and the fuel such that the first oxidant, the second oxidant, the third oxidant, the fourth oxidant, the fifth oxidant, and the sixth oxidant thermally decompose, yielding nanoparticles of a high entropy oxide composition.

23. The method of claim 22 wherein:
a fuel-to-oxidant stoichiometric ratio is less than 1.0.

24. The method of claim 22 wherein:
the solution includes a solvent selected from the group consisting of water, ethanol, acetone, and mixtures thereof, and
in step (b), the solvent evaporates creating a gel that spontaneously ignites.
